(19) United States
(12) Patent Application Publication
(10) Pub. No.: US 2017/0175794 A1
(43) Pub. Date: Jun. 22, 2017

(54) FASTENER SYSTEM AND ASSEMBLY

(71) Applicant: AIRBUS OPERATIONS LIMITED, Bristol (GB)

(72) Inventors: Philip CRESSWELL, Bristol (GB); John STUCKEY, Bristol (GB); Camille LOCATELLI, Bristol (GB)

(21) Appl. No.: 15/384,867

(22) Filed: Dec. 20, 2016

(30) Foreign Application Priority Data
Dec. 21, 2015 (GB) 1522497.5

(51) Int. Cl. F16B 39/02; F16B 35/06; F16B 37/14

(52) U.S. Cl. CPC F16B 39/021; F16B 37/145; F16B 35/06

(57) ABSTRACT

A fastener system (9) for fastening a first structure to a second structure, the fastener system (9) includes:
(i) a bolt (11) having a countersink bolt head (15), a bolt tip (17), and a threaded male portion (19) extending from the countersink bolt head (15) towards the bolt tip (17),
(ii) a nut (13) having a countersink nut head (23), a nut tip (25) and a female shank portion (27) extending from the countersink nut head (23) towards the nut tip (25), wherein the female shank portion (27) includes an inner thread (29) configured for co-operating with the threaded male portion (19) of the bolt (11), and
(iii) at least one cavity (33, 35) for a locking material, the at least one cavity (33, 35) is formed in the threaded male portion (19) of the bolt (11) and/or the inner thread of the female shank portion (27) of the nut (13).

### TECHNICAL FIELD

The present invention relates to a fastener system and an assembly. The assembly can be used on an aircraft, the assembly comprising a first aircraft structure held to a second aircraft structure by the fastener system.

### BACKGROUND

Conventional fasteners such as rivets require significant space to apply a tool for collar swaging and breaking the pin tail. The pin tail must be discarded. Complex drilling is often the only way to remove a rivet for repair, inspection or installation purposes. The rivet must then be replaced and cannot be re-used.

As an alternative to a rivet, U.S. 2014/0356094 A1 describes an assembly comprising first and second parts made of composite material held one against the other by at least one non-removable fastener system. The assembly described therein is designed to be used in an afterbody of an aeroengine, wherein an inner peg with a higher thermal expansion coefficient expands upon the high temperatures in the afterbody to secure the fastener system.

### SUMMARY

It is therefore an object to provide an improved fastener system which is secure and removable.

In accordance with a first aspect of the present invention, there is provided a fastener system for fastening a first structure to a second structure, said fastener system comprising
(i) a bolt having a countersink bolt head, a bolt tip, and a threaded male portion extending from the countersink bolt head towards the bolt tip,
(ii) a nut having a countersink nut head, a nut tip and a female shank portion extending from the countersink nut head towards the nut tip, wherein the female shank portion includes an inner thread configured for co-operating with the threaded male portion of the bolt,
   wherein the fastener system comprises at least one cavity for a locking material, said at least one cavity is formed in the threaded male portion of the bolt and/or the inner thread of the female shank portion of the nut.

This fastener system requires less tooling space and it is removable and optionally re-usable. No complex drilling is needed to remove the fastener for repair, inspection or installation purposes. This fastener system is secure, because the at least one cavity is able to hold a locking material in place. It may be easier and therefore optional to manufacture a cavity in the threaded male portion of the bolt than in the female shank portion of the nut. Furthermore, applying or inserting of a locking material may be easier and therefore optional for a cavity in the threaded male portion of the bolt than the female shank portion of the nut.

Optionally, the at least one cavity has a distance to the countersink bolt head or the nut tip, wherein the distance is at least one thread pitch. In particular when using a viscous locking material, this distance may prevent locking material from being squeezed out at the nut tip. In addition or alternatively the at least one cavity may have a distance to the bolt tip or countersink nut head, wherein the distance is at least one thread pitch. This distance may prevent locking material from being squeezed at the bolt tip into a residual space in the female shank portion.

It is optional that the at least one cavity extends over 25% or more of the threads of the threaded male portion of the bolt and/or the inner thread of the female shank portion of the nut. This option may allow use of a wider variety of locking materials and shapes thereof.

It is also optional that at least one of the at least one cavity has a longitudinal shape extending in form of a helix section crossing the threads of the threaded male portion of the bolt and/or the inner thread of the female shank portion of the nut. The helix section may cross the threads at a crossing angle to maximise the contact surface between the locking material and the threads. This crossing angle may be between 10 and 80 degrees. The helix shaped cavity may be manufactured by a linear cut in the thread at a helix angle between 10 and 85 degrees with respect to the longitudinal axis of the threaded male portion.

In a first optional embodiment, the fastener system comprises at least two cavities having a longitudinal shape extending in form of separate and parallel helix sections crossing the threads of the threaded male portion of the bolt and/or the inner thread of the female shank portion of the nut. This option may allow a redundancy of locking material to increase the security the fastener system. Furthermore, the locking material can easily be dosed by the number of identical plastic inserts or tabs used as locking material. The at least two cavities may be arranged on opposite sides of the threaded male portion of the bolt and/or the inner thread of the female shank portion of the nut as sections of a double-helix. For N cavities, where N>2, the cavities may be arranged evenly distributed with an angular distance of 360°/N.

The local diameter of the threaded male portion of the bolt may be reduced by the at least one cavity by 10% or less, optionally 8%, with respect to the general diameter of the threaded male portion of the bolt. Thereby, the cavity is deep enough to secure a locking material without compromising the structural integrity of the bolt.

To facilitate the installation of the fastener system it may be optional that the locking material is already preinstalled and part of the fastener system. It may be partially located in at least one of the at least one cavity and may partially protrude out of said at least one of the at least one cavity such that the locking material increases the friction between the threaded male portion of the bolt and the threaded female shank portion of the nut when the threaded male portion of the bolt is fully screwed into the female shank portion of the nut. “Fully” shall mean herein with a sufficient amount of rotations to engage with at least 50% of the threads to establish a secure connection between the bolt and the nut.

With the preinstalled locking material as part of the fastener system, the locking material may increase the friction between the threaded male portion of the bolt and the threaded female shank portion of the nut when the threaded male portion of the bolt is fully screwed into the female shank portion of the nut with a locking torque below a maximum locking torque and a breakaway torque above a minimum breakaway torque depending on the diameter of the threaded male portion according to the following table:

| Diameter of the threaded | | |
|---|---|---|
| male portion | Maximum locking | Minimum breakaway |
| of the bolt [mm] | torque [Nm] | torque [Nm] |
| 4.83 | 1.4 | 0.2 |
| 5.56 | 1.7 | 0.3 |
| 6.35 | 1.9 | 0.4 |
| 7.92 | 3.9 | 0.7 |
| 9.52 | 4.5 | 1.1 |
| 11.1 | 6.8 | 1.6 |
| 12.7 | 9.6 | 2.0 |
| 14.3 | 12.4 | 2.7 |
| 15.9 | 14.7 | 3.6 |
| 19.0 | 20.9 | 5.6 |
| 22.2 | 27.6 | 7.9 |
| 25.4 | 34.4 | 10.1 |
| 28.6 | 42.0 | 13.2 |

including interpolations therefrom, optionally linear or other suitable interpolations. “Locking torque” herein refers to the torque required to screw the bolt into the nut and out of it. “Breakaway torque” herein refers to the torque required to start the unseated nut in the removal direction. The exact definitions and test conditions can be found in the Aerospace Industries Association of America's National Aerospace Standard Document No. NASM25027, first revision of 12 Dec. 2012.

The locking material may be a plastic insert or a thread-locking fluid like Loctite® or another suitable material for increasing the friction between the threads. A plastic insert may be optional for re-using the fastener system as the plastic insert can be easily renewed. A thread-locking fluid like Loctite® may provide more frictional contact surface with the threads and may need to be cleaned away before it is re-applied for re-using the fastener system.

The countersink bolt head and/or the countersink nut head may comprise engagement surfaces for rotating the bolt and/or the nut by a tool configured to engage with the engagement surfaces. Thereby, less tooling space is needed compared to a rivet with a breakable pin tail.

The countersink bolt head and/or the countersink nut head may comprise countersink surfaces for bearing against the countersink of the first structure and/or the countersink of the second structure, respectively. The countersink surfaces optionally have countersink angles of about 100 degrees or more, particularly of about 130 degrees. The countersink angles of the fastener system and the countersink angles of the countersinks of the first and second structure are optionally the same to distribute the induced stress on the structure on as much surface area as possible while benefitting from a centring effect of the countersinks.

In accordance with a second aspect of the present invention, there is provided an assembly comprising
(i) a first structure having a first countersink at a first surface,
(ii) a second structure having a second countersink at a second surface,
(iii) at least one fastener system, each of said at least one fastener system comprising
   a) a bolt having a countersink bolt head, a bolt tip, and a threaded male portion extending from the countersink bolt head towards the bolt tip, the countersink bolt head being positioned in the first countersink and having a bolt head surface, wherein the bolt head surface is flush with the first surface of the first structure,
   b) a nut having a countersink nut head, a nut tip and a female shank portion extending from the countersink nut head towards the nut tip, wherein the female shank portion includes an inner thread co-operating with the threaded male portion of the bolt, the countersink nut head being positioned in the second countersink and having a nut head surface, wherein the nut head surface is flush with the second surface of the second structure,
   wherein the fastener system comprises a locking material in at least one cavity, said at least one cavity is formed in the threaded male portion of the bolt and/or the inner thread of the female shank portion of the nut.

This assembly requires less tooling space for installation and can easily be unassembled by removing the fastener system. No complex drilling is needed to remove the fastener for repair, inspection or installation purposes. This assembly is secure, because the fastener system is secured by the locking material fixed in the at least one cavity. It may be easier and therefore optional to manufacture a cavity in the threaded male portion of the bolt than the female shank portion of the nut. Furthermore, applying or inserting of a locking material may be easier and therefore optional for a cavity in the threaded male portion of the bolt than the female shank portion of the nut.

The first structure and/or the second structure may comprise composite material. The fastener system does not laterally expand during installation and is therefore particularly suited to fasten structures comprising composite material.

### BRIEF DESCRIPTION OF THE DRAWINGS

Embodiments will now be described by way of example only with reference to the following figures of which:

FIG. 1 is a schematic top view on an aircraft comprising one or more assemblies as an exemplary embodiment;

FIG. 2 is a side view on a bolt and a semi-transparent side view on a nut of a fastener system as an exemplary embodiment;

FIG. 3 are two diagrams of the torque characteristics of an exemplary embodiment;

FIG. 4 is a sectional side view on an assembly as an exemplary embodiment;

FIG. 5 is a mesh of the outlines of a locking insert as part of an exemplary embodiment;

FIG. 6 is cross-sectional detail view of a threaded male portion of a bolt as part of an exemplary embodiment.

### DETAILED DESCRIPTION

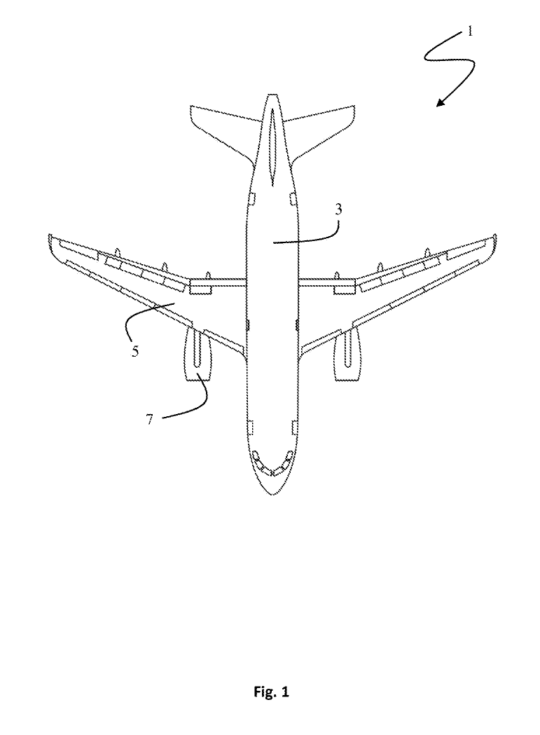

FIG. 1 shows a commercial passenger aircraft 1 with a fuselage 3, fixed wings 5 and aircraft engines 7. The aircraft 1 may comprise assembled structures requiring less tooling space with an easily removable and re-usable fastener system. The assembled structures may need to be disassembled for repair, inspection or installation purposes.

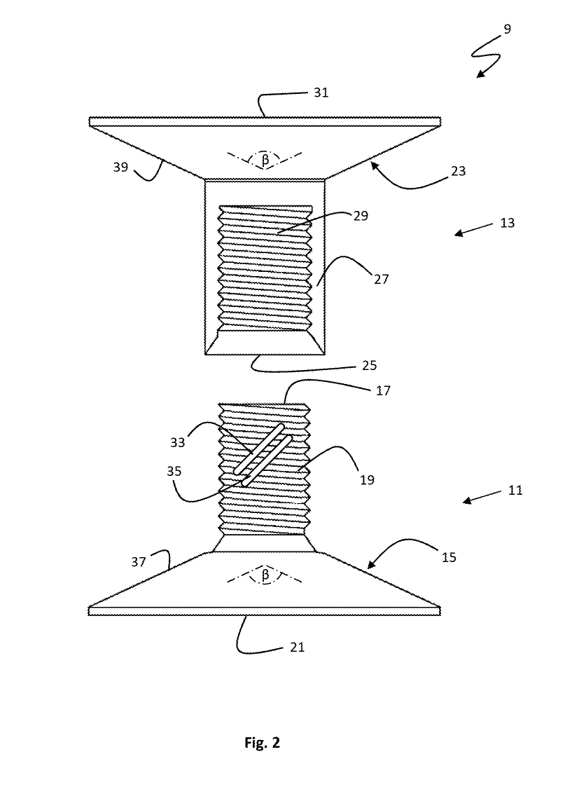

FIG. 2 shows an easily removable and re-usable fastener system 9 comprising a bolt 11 and a nut 13. The bolt 11 has a countersink bolt head 15, a bolt tip 17, and a threaded male portion 19 extending from the countersink bolt head 15 towards the bolt tip 17. The countersink bolt head 15 has a bolt head surface 21 configured to be flush with a surface of a structure when the countersink bolt head 15 is positioned in a countersink of the first structure. The nut 13 has a countersink nut head 23, a nut tip 25 and a female shank portion 27 extending from the countersink nut head 23 towards the nut tip 25. The female shank portion 27 includes an inner thread 29 configured for co-operating with the threaded male portion 19 of the bolt 11. The countersink nut head 23 has a nut head surface 31 configured to be flush with a surface of a second structure when the countersink nut head 23 is positioned in a countersink of the second structure. The threaded male portion 19 of the bolt 11 comprises two cavities 33, 35 for a locking material.

The cavities 33, 35 have a longitudinal shape extending in form of separate and parallel helix sections crossing more than 25% of the threads of the threaded male portion 19 of the bolt 11. Both cavities 33, 35 have a distance to the countersink bolt head 15 and to the bolt tip 17 of at least one thread pitch. The helix chirality of the cavities 33, 35 is different from the chirality of the threads.

The cavities 33, 35 are configured to fix a locking material partially located in them and partially protruding out of them such that the locking material increases the friction between the threaded male portion 19 of the bolt 11 and the threaded female shank portion 27 of the nut 13 when the threaded male portion 19 of the bolt 11 is fully screwed into the female shank portion 27 of the nut 13. The locking material may be a plastic insert or a thread-locking fluid like Loctite® optionally pre-installed as part of the fastener system 9. The locking material can increase the friction such that the fastener system has a locking torque below a maximum locking torque and a breakaway torque above a minimum breakaway torque depending on the diameter of the threaded male portion 19. For instance, with a general diameter of 4.83 mm of threaded male portion 19, the locking torque is 1.4 Nm or below and the breakaway torque is 0.2 Nm or above. This means that it requires a torque of 1.4 Nm or less to screw the bolt 11 into the nut 13 (and out of it) and 0.2 Nm or more to start the unseated nut 13 (or bolt 11) in the removal direction.

The countersink bolt head 15 and/or the countersink nut head 23 comprise engagement surfaces (not shown) for rotating the bolt 11 and/or the nut 13 by a tool (not shown) configured to engage with the engagement surfaces. These engagement surfaces can be part of a slot, a cross-recess, a square, a hex, a pentagon, torx drive or another suitable feature for receiving a mating tool like a screw driver, wrench or key to apply the necessary torque. The countersink bolt head 15 and the countersink nut head 23 both comprise countersink surfaces 37, 39 for bearing against countersinks of structures to be held together by the fastener system 9. In this example, the countersink bolt head 15 and the countersink nut head 23 both have a countersink angle β of about 130 degrees.

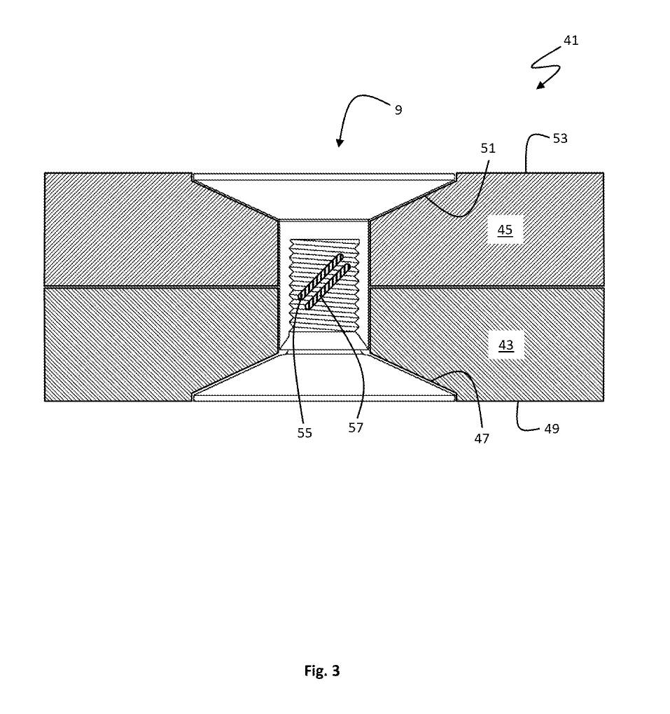

FIG. 3 shows the torque characteristics of an embodiment with preinstalled locking material as part of the fastener system 9. The locking material increases the friction between the threaded male portion 19 of the bolt 11 and the threaded female shank portion 27 of the nut 13 when the threaded male portion 19 of the bolt 11 is fully screwed into the female shank portion 27 of the nut 13 with a locking torque below a maximum locking torque MLT and a breakaway torque above a minimum breakaway torque MBT. The upper plot is an interpolation of the table in paragraph [0013] and shows the maximum locking torque MLT and the minimum breakaway torque MBT both in newton meter (Nm) depending on the general diameter D of the threaded male portion 19 of the bolt 11 between 10 mm and 40 mm. The lower plot is also an interpolation of the table in paragraph [0013] and shows the maximum locking torque MLT and the minimum breakaway torque MBT both in Nm depending on the general diameter D of the threaded male portion 19 of the bolt 11 between 0 mm and 10 mm.

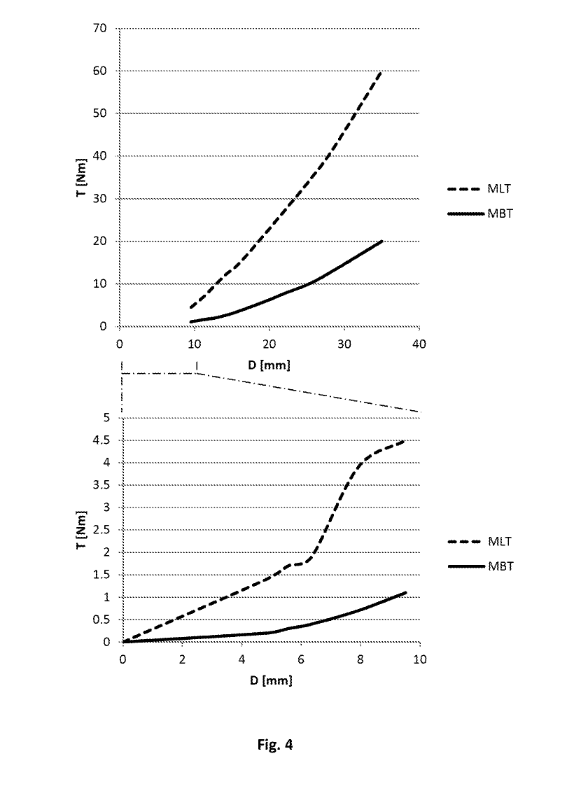

FIG. 4 shows an assembly 41 comprising a first structure 43 and a second structure 45. The structures 43, 45 may comprise composite material. The first structure 43 has a first countersink 47 at a first surface 49 and the second structure 45 has a second countersink 51 at a second surface 53. The structures 43, 45 are held together by the fastener system 9 of FIG. 2 comprising a locking material in form of plastic inserts or tabs 55, 57 partially contained in the cavities 33, 35.

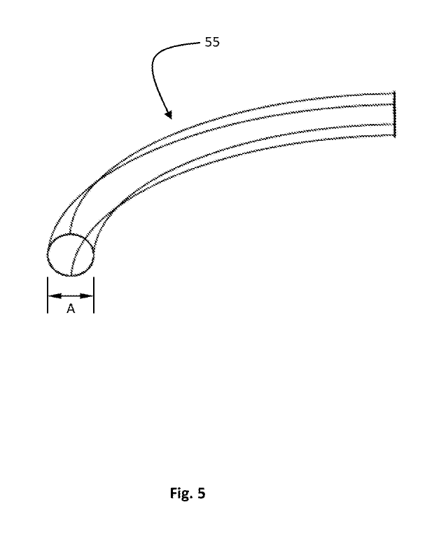

FIG. 5 is a mesh of the outlines of either one of the locking inserts or tabs 55, 57. In this example, the locking insert 55 has a longitudinal tubular shape along a helix with a circular cross-section and a diameter A. The length of the locking insert 55 is at least 25% of the sum of all threat pitches of the threaded male portion 19 of the bolt 11.

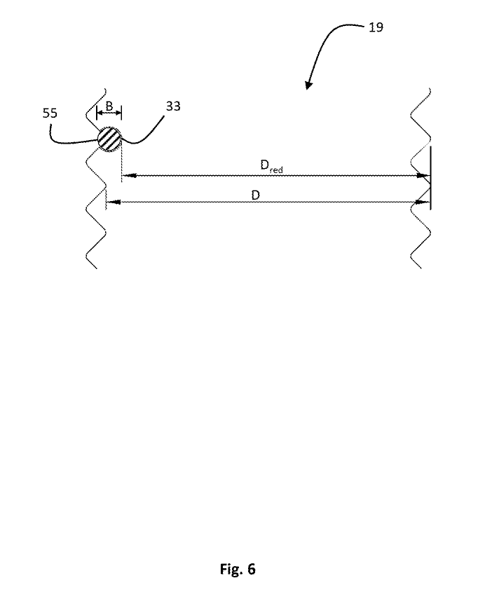

FIG. 6 shows a cross-sectional detail of the threaded male portion 19 of the bolt 11 with the locking insert 55 partially contained in the cavity 33. In this embodiment, there is only one cavity 33 and one locking insert 55. The cavity 33 has in this example a longitudinal tubular shape along a helix with a circular cross-section and a diameter B to accommodate the locking insert 55 of diameter A. Diameter B can be the same as diameter A or slightly larger to be able to receive the locking insert 55 while fixing its position. The locking insert 55 may be resilient to a certain extend to allow being inserted into the cavity 33.

The threaded male portion 19 of the bolt 11 has a general diameter D and a reduced local diameter D_{red} where the cavity 33 is. To guarantee the structural integrity of the bolt 11, the local diameter D_{red} is only reduced by 10% or less, optionally about 8%, with respect to the general diameter of the threaded male portion of the bolt. This means (D−D_{red})/D≦0.1, optionally (D−D_{red})/D≈0.08.

Where, in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as optional, preferable, advantageous, convenient or the like are optional and do not limit the scope of the independent claims.

The above embodiments are to be understood as illustrative examples of the invention. It is to be understood that any feature described in relation to any one embodiment may be used alone, or in combination with other features described, and may also be used in combination with one or more features of any other of the embodiments, or any combination of any other of the embodiments. While at least one exemplary embodiment has been shown and described, it should be understood that other modifications, substitutions and alternatives are apparent to one of ordinary skill in the art and may be changed without departing from the scope of the subject matter described herein, and this application is intended to cover any adaptations or variations of the specific embodiments discussed herein.

In addition, “comprising” does not exclude other elements or steps, and “a” or “one” does not exclude a plural number. Furthermore, characteristics or steps which have been described with reference to one of the above exemplary embodiments may also be used in combination with other characteristics or steps of other exemplary embodiments described above. It should be understood that there should be embodied within the scope of the patent warranted hereon all such modifications as reasonably and properly come within the scope of the contribution to the art. Such modifications, substitutions and alternatives can be made without departing from the spirit and scope of the invention, which should be determined from the appended claims and their legal equivalents.

1.-15. (canceled)

16. A fastener system configured to fasten a first structure to a second structure, said fastener system comprising:
(i) a bolt having a countersink bolt head, a bolt tip, and a threaded male portion extending from the countersink bolt head towards the bolt tip,
(ii) a nut having a countersink nut head, a nut tip and a female shank portion extending from the countersink nut head towards the nut tip, wherein the female shank portion includes an inner thread configured to cooperate with the threaded male portion of the bolt, and
(iii) at least one cavity configured for a locking material, said at least one cavity is formed in the threaded male portion of the bolt and/or the inner thread of the female shank portion of the nut.

17. The fastener system of claim 16, wherein said at least one cavity has a distance to the countersink bolt head and the nut tip, wherein the distance is at least one thread pitch.

18. The fastener system of claim 16, wherein said at least one cavity has a distance to the bolt tip and the countersink nut head, wherein the distance is at least one thread pitch.

19. The fastener system of claim 16, wherein the at least one cavity extends over 25% or more of the threads of the threaded male portion of the bolt and/or the inner thread of the female shank portion of the nut.

20. The fastener system of claim 16, wherein at least one of the at least one cavity has a longitudinal shape extending in form of a helix section crossing the threads of the threaded male portion of the bolt and/or the inner thread of the female shank portion of the nut.

21. The fastener system of claim 16, wherein the fastener system comprises at least two cavities having a longitudinal shape extending in form of separate and parallel helix sections crossing the threads of the threaded male portion of the bolt and/or the inner thread of the female shank portion of the nut.

22. The fastener system of claim 16, wherein the fastener system comprises N cavities, where N>1, the cavities having an angular distance of 360°/N to each other.

23. The fastener system of claim 16, wherein a local diameter (D_{red}) of the threaded male portion of the bolt is reduced by the at least one cavity by 10% or less with respect to a general diameter (D) of the threaded male portion of the bolt.

24. The fastener system of claim 16, further comprising a locking material partially located in at least one of the at least one cavity and partially protruding out of said at least one of the at least one cavity such that the locking material increases friction between the threaded male portion of the bolt and the threaded female shank portion of the nut while the threaded male portion of the bolt is fully screwed into the female shank portion of the nut.

25. The fastener system of claim 24, wherein the locking material increases friction between the threaded male portion of the bolt and the threaded female shank portion of the nut while the threaded male portion of the bolt is fully screwed into the female shank portion of the nut with a locking torque below a maximum locking torque (MLT) and a breakaway torque above a minimum breakaway torque (MBT) depending on a general diameter (D) of the threaded male portion according to the following table:

| Diameter of the threaded | | |
|---|---|---|
| male portion | Maximum locking | Minimum breakaway |
| of the bolt [mm] | torque [Nm] | torque [Nm] |
| 4.83 | 1.4 | 0.2 |
| 5.56 | 1.7 | 0.3 |
| 6.35 | 1.9 | 0.4 |
| 7.92 | 3.9 | 0.7 |
| 9.52 | 4.5 | 1.1 |
| 11.1 | 6.8 | 1.6 |
| 12.7 | 9.6 | 2.0 |
| 14.3 | 12.4 | 2.7 |
| 15.9 | 14.7 | 3.6 |
| 19.0 | 20.9 | 5.6 |
| 22.2 | 27.6 | 7.9 |
| 25.4 | 34.4 | 10.1 |
| 28.6 | 42.0 | 13.2 |

including interpolations therefrom.

26. The fastener system of claim 25, wherein the locking material is a plastic insert or a thread-locking fluid.

27. The fastener system of claim 16, wherein the countersink bolt head and/or the countersink nut head comprise engagement surfaces for rotating the bolt and/or the nut by a tool configured to engage with the engagement surfaces.

28. The fastener system of claim 16, wherein the countersink bolt head and/or the countersink nut head have a countersink angle (β) of at least 100 degrees.

29. An assembly comprising
(i) a first structure having a first countersink at a first surface,
(ii) a second structure having a second countersink at a second surface, and
(iii) at least one fastener system, each of said at least one fastener system comprising:
a) a bolt having a countersink bolt head, a bolt tip, and a threaded male portion extending form the countersink bolt head towards the bolt tip, the countersink bolt head being positioned in the first countersink and having a bolt head surface, wherein the bolt head surface is flush with the first surface of the first structure,
b) a nut having a countersink nut head, a nut tip and a female shank portion extending from the countersink nut head towards the nut tip, wherein the female shank portion includes an inner thread co-operating with the threaded male portion of the bolt, the countersink nut head being positioned in the second countersink and having a nut head surface, wherein the nut head surface is flush with the second surface of the second structure, and
c) a locking material in at least one cavity, said at least one cavity is formed in the threaded male portion of the bolt and/or the inner thread of the female shank portion of the nut.

30. The assembly of claim 29, wherein the first structure and/or the second structure comprise composite material.

31. A fastener system comprising:
a bolt having a countersink bolt head, a bolt tip, and a threaded male portion between the countersink bolt head and the bolt tip;
a nut including a countersink nut head, a nut tip and a female shank between the countersink nut head and the nut tip, wherein the female shank includes an inner thread configured to cooperate with the threaded male portion of the bolt, and
a cavity configured to receive a locking material, the cavity is in the threaded male portion of the bolt or the inner thread of the female shank of the nut.
